(19) United States
(12) Patent Application Publication
(10) Pub. No.: US 2004/0142054 A1
(43) Pub. Date: Jul. 22, 2004

(54) Blow molding mold assembly with a dyeing device

(76) Inventors: Hsizh Jui Feng, Taichung City (TW); Chi-Cheng Fu, Su-Lin (TW); Hsiao-Chien Min, Taipei City (TW)

Correspondence Address: CHARLES E. BAXLEY, ESQ., 90 JOHN STREET, THIRD FLOOR, NEW YORK, NY, 10038, US

(21) Appl. No.: 10/751,627

(22) Filed: Jan. 5, 2004

Related U.S. Application Data
(63) Continuation-in-part of application No. 09/812,384, filed on Mar. 21, 2001, now abandoned.

(51) Int. Cl. B29C 45/16

(52) U.S. Cl. 425/130; 425/375

(57) ABSTRACT

A blow molding mold assembly includes a first mold having a recess for receiving a dye permeable member therein. A second mold is located under the first mold and a mediate mold is clamped between the first mold and the second mold. A connection pipe assembly extends through the first mold and communicates with the dye permeable member so as to let dye attached on the material located on the mediate mold via the dye permeable member.

### FIELD OF THE INVENTION

This is a Continuation-In-Part application for applicant's former application with the application Ser. No. 09/812,384, filed on Mar. 21, 2001.

### BACKGROUND OF THE INVENTION

A conventional product made by way of blow molding generally includes a single plastic layer and some patterns are formed on the product. In order to have a better esthetic feature that attracts consumers' attention, the patterns are colored by manual after the product is made. The colors on the patterns cannot last long and are easily worn out. An improved way to achieve the purpose is to make two layers one of which has an aperture and the other layer has colored patterns. The colored patterns have tapered outer periphery so as to be engaged with the periphery of the aperture. In other words, the two layers are overlapped and the colored patterns are shown in the aperture. Although both of the layers are made by way of blow molding, the manufacturers have to prepare two different molds and the two layers are assembled by manual way. The two layers are made by different material having ingredients so that they have different shrink rate and the size of the aperture could not meet the size of the colored patterns.

The present invention intends to provide a mold assembly that allows the dyeing process to be completed when molding the product.

### SUMMARY OF THE INVENTION

In accordance with one aspect of the present invention, there is provided a blow molding mold assembly and including a first mold having a recess for receiving a dye permeable member therein and a second mold is located under the first mold with a mediate mold is clamped between the first mold and the second mold. Material is injected between the mediate mold and the second mold and dye is attached on the material via the dye permeable member.

The primary object of the present invention is to provide a blow molding mold assembly wherein the product can be colored during the molding process.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is a perspective view to show an article molded by the blow molding mold assembly of the present invention;

FIG. 2 is an exploded view to show the blow molding mold assembly of the present invention;

FIG. 3 is a cross sectional view to show a layer of material to be made into an article as shown in FIG. 1 is injected between-the first mold and the mediate mold of the blow molding mold assembly of the present invention;

FIG. 4 is an enlarged view to show that the sponge is in contact with the article molded in the blow molding mold assembly of the present invention;

FIG. 5 shows the article is separated from the first mold and the second mold by raising the position pins of the movable plate, and FIG. 6 is an enlarged view to show the sponge connected to the fist mold wherein the sponge is separated from the article.

### DETAILED DESCRIPTION OF THE PREFERRED EMBODIMENT

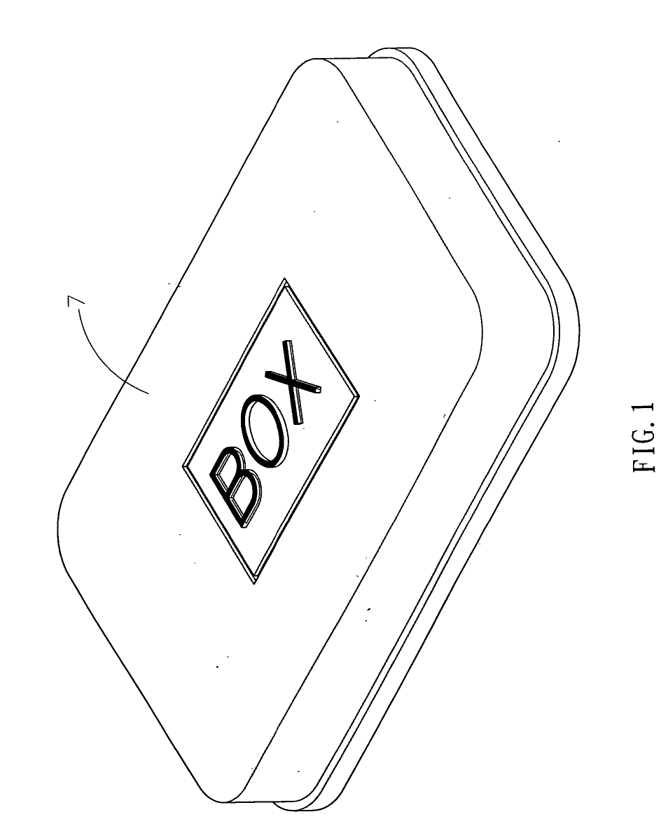

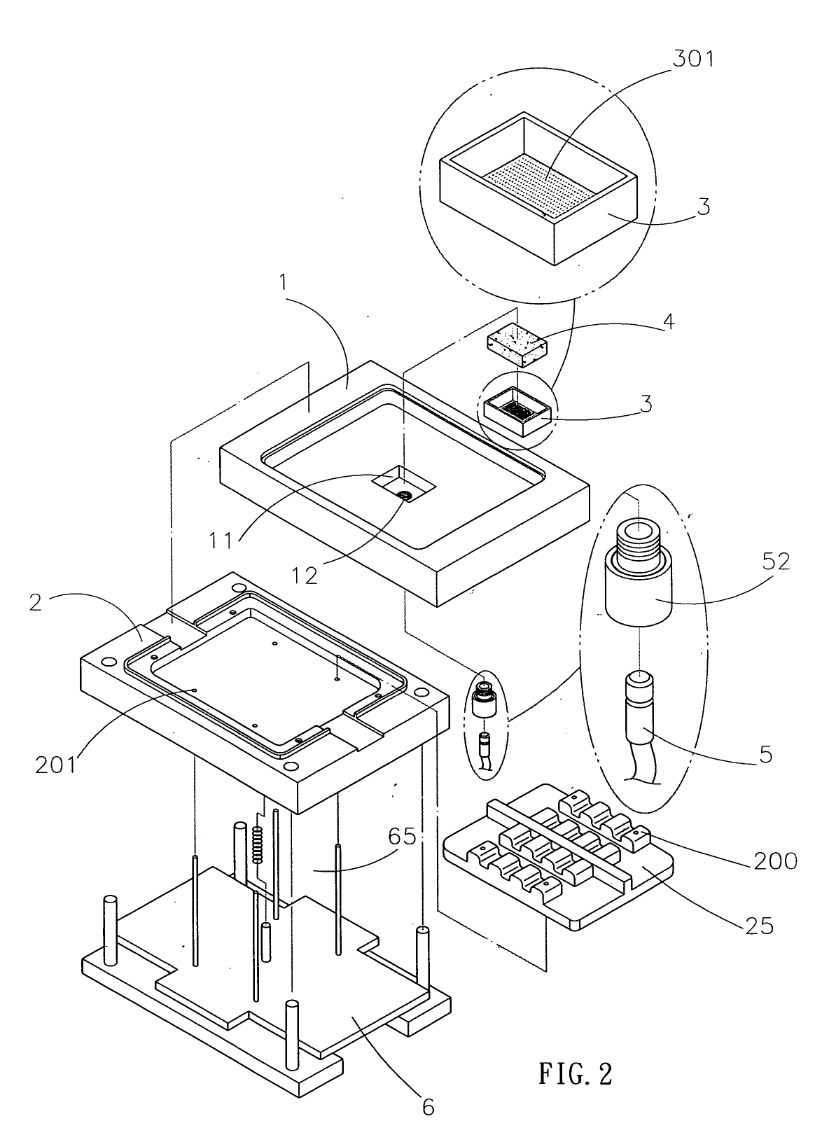

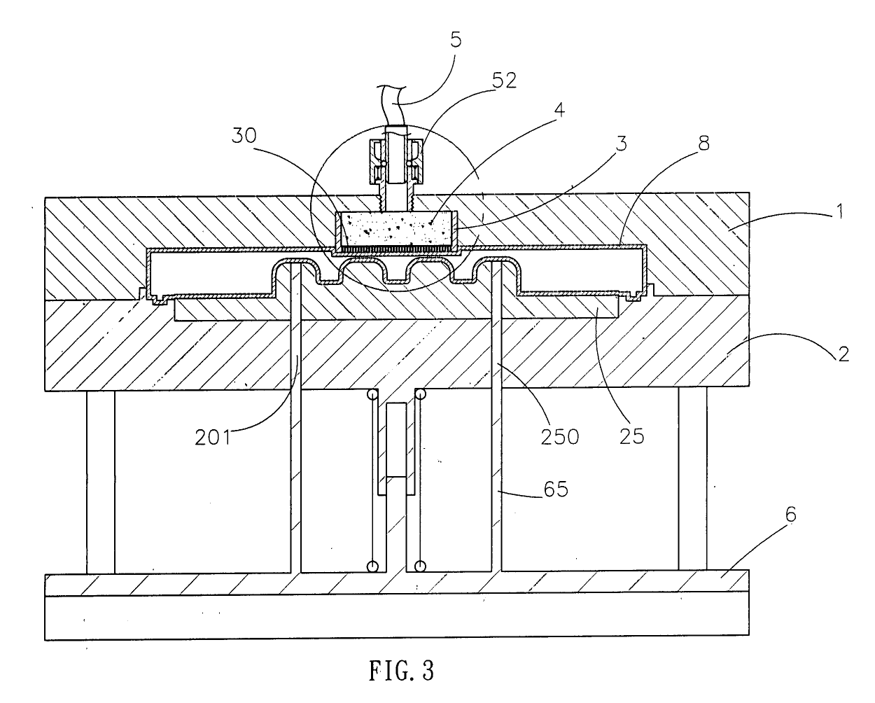

Referring to FIGS. 1 to 3, the blow molding mold assembly of the present invention comprises a first mold 1 having a recess 11 defined in a surface thereof so as to receive a dye permeable member therein. The dye permeable member includes a frame 3 having a netted bottom 30 and a sponge member 4 which is received in the frame 3. The netted bottom 30 includes tiny holes 301 and the diameter of each of the tiny holes 301 is less than 1.5 mm. A pipe assembly extends through the first mold 1 and communicates with the sponge 4 so that oily dye is absorbed by the sponge member 4 via the pipe assembly. The pipe assembly in this embodiment includes a fitting 52 which threadedly engaged with a threaded hole 12 defined through the first mold 1 and a hose 5 is engaged with the fitting 52. The threaded hole 12 communicates with the recess in the first mold 1.

A second mold 2 is located under the first mold 1 and a mediate mold 25 is engaged with a recessed area defined in the second mold 2. The mediate mold 25 has patterns defined thereon.

A movable plate 6 is located under the second mold and includes position pins 65 extending therefrom. The position pins 65 extend through holes 201 in the surface of the recessed area of the second mold 2, and holes 250 defined through the mediate mold 25.

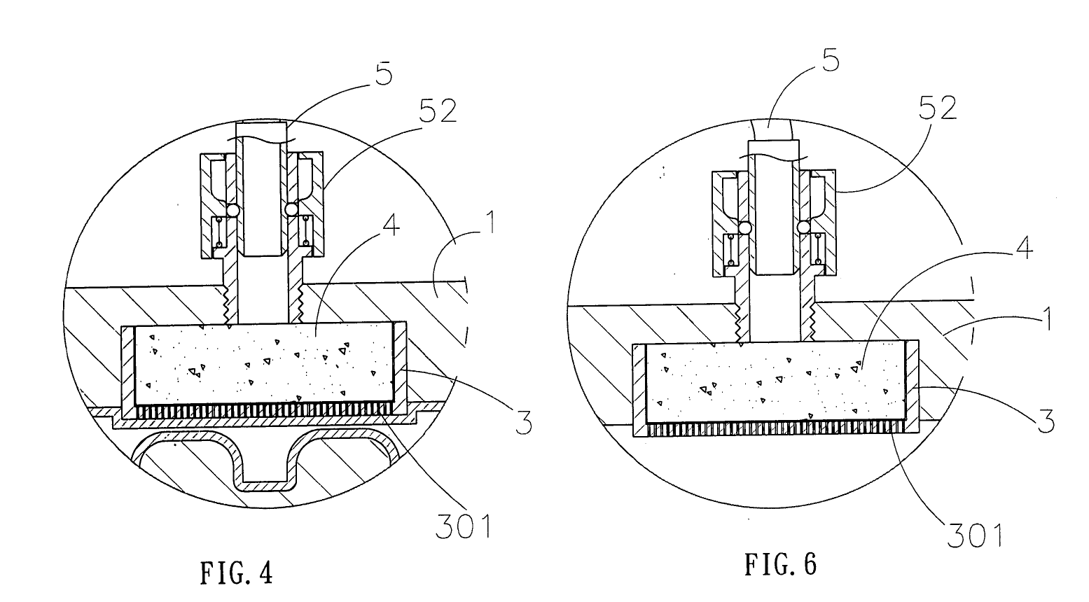

As shown in FIG. 4, a layer of material 8 is injected between the space between the second mold 2 and the mediate mold 25 so as to form an article having the exact patterns on the mediate mold 25. The dye is permeable through the tiny holes 301 in the netted member 30 of the frame 3 and attached on an outer surface of the article made of the material 8. The tiny holes 301 are sized that the oily dye properly flows onto the article to obtain a perfect colored pattern 7. The dye is quickly dried and securely attached on the article made of the material 8.

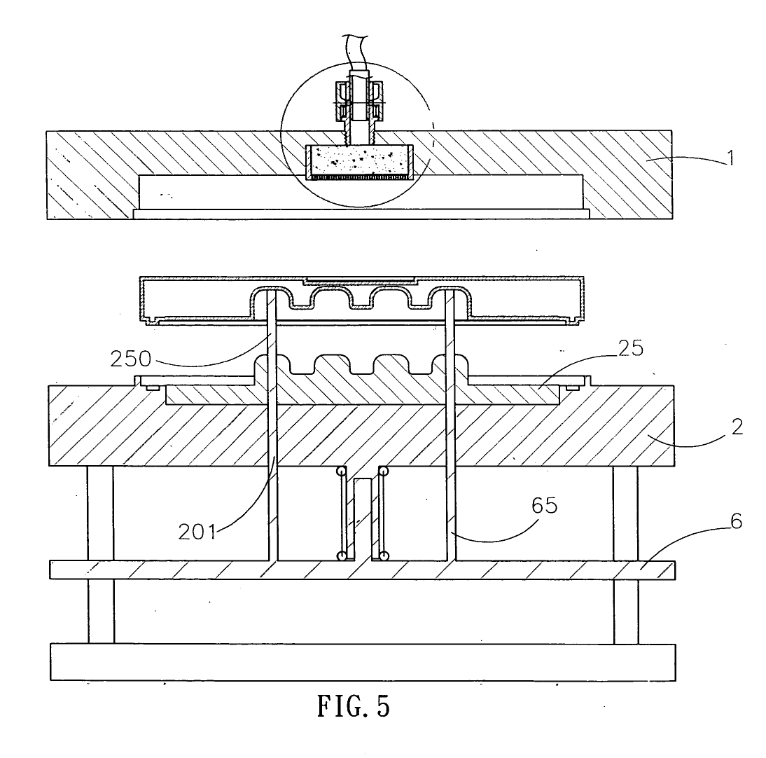

As shown in FIGS. 5 and 6, the first mold 1′ is lifted upward and separated from the second mold 2, and the movable plate 6 is than raised the distal end of the position pins 65 kick the article out from the mediate mold 25. The article 1 is then completed with a colored pattern 7 marked thereon. By the mold assembly, the article can be done and the colored pattern 7 is completed within one molding process.

While we have shown and described various embodiments in accordance with the present invention, it should be clear to those skilled in the art that further embodiments may be made without departing from the scope and spirit of the present invention.

What is claimed is:

1. A blow molding mold assembly comprising:
a first mold, a dye permeable member connected to said first mold;
a second mold located under said first mold;
a mediate mold clamped between said first mold and said second mold, said mediate mold facing said dye permeable member, and
a movable plate located under said second mold and having position pins extending therefrom, said position pins extending through said second mold and said mediate mold so as to be adapted to kick out an article molded between said first mold and said mediate mold.

2. The assembly as claimed in claim 1 further comprising a recess defined in a surface of said first mold and said dye permeable member engaged with said recess.

3. The assembly as claimed in claim 1, wherein said dye permeable member includes a frame having a netted bottom and a sponge member is received in said frame, a pipe assembly extending through said first mold and communicating with said sponge.

4. The assembly as claimed in claim 3, wherein said pipe assembly includes a fitting threadedly connected to said first mold and a hose engaged with said fitting.

5. The assembly as claimed in claim 3 wherein said netted bottom includes tiny holes and a diameter of each tiny hole is less than 1.5 mm.
